(19) United States
(12) Patent Application Publication
(10) Pub. No.: US 2014/0141736 A1
(43) Pub. Date: May 22, 2014

(54) WIRELESS COMMUNICATION DEVICE AND POWER CONTROL METHOD

(71) Applicant: FUJITSU LIMITED, KAWASAKI-SHI (JP)

(72) Inventors: Hirotoshi KANNO, Kawasaki (JP); Mitsunori MAEDA, Kawasaki (JP); Takayoshi ODE, Yokohama (JP)

(73) Assignee: FUJITSU LIMITED, KAWASAKI-SHI (JP)

(21) Appl. No.: 14/071,293

(22) Filed: Nov. 4, 2013

(30) Foreign Application Priority Data
Nov. 16, 2012 (JP) 2012-252551

(51) Int. Cl. H04W 52/26

(52) U.S. Cl. CPC H04W 52/26
USPC 455/127.1

(57) ABSTRACT

A wireless communication device includes: an amplifier configured to amplify a transmission signal to a given power level, the transmission signal being transmitted in wireless communication; and a processor coupled to the amplifier and configured to: select a communication protocol that is used for the wireless communication, from among a plurality of communication protocols including a first communication protocol and a second communication protocol of a lower communication speed than the first communication protocol, in accordance with a condition of the wireless communication, and control power source voltage of the amplifier by a control scheme determined in accordance with a communication speed of the selected communication protocol.

### CROSS-REFERENCE TO RELATED APPLICATION

This application is based upon and claims the benefit of priority of the prior Japanese Patent Application No. 2012-252551, filed on Nov. 16, 2012, the entire contents of which are incorporated herein by reference.

### FIELD

The embodiments discussed herein are related to a wireless communication device, a wireless communication circuit, and a power control method for wireless communication.

### BACKGROUND

In a wireless communication device such as a portable telephone, power which is consumed in a wireless communication circuit which executes wireless communication makes up the majority of the whole power consumption of the device. For example, in a state of calling, 70 percent to 80 percent of consumption current is consumed in a wireless communication circuit. Examples of a factor that the wireless communication circuit largely consumes power include a factor that the wireless communication circuit is composed of a circuit which processes an analog signal and a factor that the wireless communication circuit processes a signal of a high frequency from several hundred MHz to several GHz.

Further, the wireless communication circuit amplifies a transmission signal to a given power level by using a power amplifier, so as to transmit the signal wirelessly. The power amplifier is a main constituent element of the wireless communication circuit, so that power consumed by the power amplifier accounts for a large proportion of the power consumption in the wireless communication circuit. Therefore, reduction in power consumed by the power amplifier brings reduction in power consumption of the wireless communication circuit.

Japanese Laid-open Patent Publication No. 2005-269440, Japanese Laid-open Patent Publication No. 2011-9923, Japanese Laid-open Patent Publication No. 2005-117315, and Japanese Laid-open Patent Publication No. 2005-20696 are examples of related art.

### SUMMARY

According to an aspect of the invention, a wireless communication device includes: an amplifier configured to amplify a transmission signal to a given power level, the transmission signal being transmitted in wireless communication; and a processor coupled to the amplifier and configured to: select a communication protocol that is used for the wireless communication, from among a plurality of communication protocols including a first communication protocol and a second communication protocol of a lower communication speed than the first communication protocol, in accordance with a condition of the wireless communication, and control power source voltage of the amplifier by a control scheme determined in accordance with a communication speed of the selected communication protocol.

The object and advantages of certain embodiments will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the functional configuration of a wireless communication device suitable for carrying out some example embodiments;

FIG. 2 illustrates path switching suitable for use in practicing some example embodiments;

FIG. 3 illustrates a calculation example of a delay amount in accordance with some example embodiments;

FIG. 4 illustrates a processing sequence of the path switching suitable for use in practicing some example embodiments;

FIG. 5 is a flowchart illustrating a process of path switching processing suitable for use in practicing some example embodiments;

FIG. 6 is a flowchart illustrating a process of delay correction processing suitable for use in practicing some example embodiments; and

FIG. 7 illustrates a hardware configuration example of the wireless communication device suitable for carrying out some example embodiments.

### DESCRIPTION OF EMBODIMENTS

A wireless communication device and a power control method according to the embodiments of the present disclosure are described in detail below in reference to the accompanying drawings. Here, the present disclosure is not limited by these embodiments.

While inventing the present embodiments, observations were made regarding a related art. Such observations include the following, for example.

In techniques of the related art, for reduction in power consumption of a power amplifier, envelope tracking (ET) and envelope elimination and restoration (EER) are, for example, widely used. The ET is a method for varying power source voltage of a power amplifier depending on an amplitude variation component of a modulation signal. Specifically, in the ET, power source voltage of a power amplifier is raised when amplitude of a modulation signal is large, while power source voltage of the power amplifier is lowered when amplitude of a modulation signal is small. Thus, in the ET, power source voltage of a power amplifier is varied in accordance with an envelope, so as to raise efficiency of power source supply.

The EER is a method in which power source voltage of a power amplifier is varied and the power amplifier is operated by switching so as to reproduce a part, which corresponds to amplitude modulation, of a modulation signal. Specifically, in the EER, a phase modulation component of a modulation signal is amplified by a switching amplifier so as to vary a power source of a power amplifier along with amplitude variation of the modulation signal. Thus, in the EER, a modulation signal is reproduced by a power amplifier output so as to raise efficiency of power source supply.

Further, in the ET, an envelope is measured in a path different from a main path through which a modulation signal is inputted into a power amplifier and a measurement result is used for power source voltage control of the power amplifier, so that delay correction of both of the paths is performed. On the other hand, delay correction between a main path of a signal of a phase modulation component and a path on the side of a power source circuit which reproduces a part corresponding to amplitude modulation is performed in the EER as well, but the effect with respect to the property is larger than that of the ET. Therefore, higher precision by which a gap between a phase modulation signal and amplitude modulation by a power source is set to be approximately 1.5 nsec is demanded in the case of the EER.

In the techniques of the related art, it may be difficult for a wireless communication device or the like which employs a plurality of communication systems of which bandwidths are different from each other to realize reduction in power consumption with high performance.

For example, both of a circuit corresponding to a long term evolution (LTE) system for a high speed and a circuit corresponding to a Wideband Code Division Multiple Access (WCDMA) system for a lower speed than the LTE are mounted on portable telephones of recent years. The portable telephones execute communication by using the LTE in environments in which the LTE is operable and execute communication by using the WCDMA in environments in which the LTE is not operable.

When a power amplifier of such portable telephone is controlled by the ET, a state that the low-speed WCDMA is employed has allowance for delay correction, allowing execution of further reduction in power consumption. On the other hand, when the power amplifier of the portable telephone is controlled by the EER, execution of delay correction is difficult in a state that the high-speed LTE is used, deteriorating accuracy of a transmitted signal.

That is, the EER system is more favorable to control an operation of a power amplifier with high efficiency, but delay correction in high-speed communication is difficult. Therefore, it is difficult to apply the EER system in high-speed communication such as the LTE. On the other hand, the ET is relatively easily applicable for a low-speed communication system and a high-speed communication system, but less reduction in power consumption is expected compared to the EER.

Therefore, according to the present embodiments, it is desirable to provide a wireless communication device, a wireless communication circuit, and a power control method which enable improvement of performance in reduction in power consumption.

A wireless communication device according to example embodiment is a device corresponding to a multimode system and includes a circuit corresponding to a high-speed communication system and a circuit corresponding to a low-speed communication system. The wireless communication device is a terminal such as a portable telephone, a smartphone, laptop computer, or tablet computer for example, and executes wireless communication by using the LTE system or the WCDMA system. Such a wireless communication device switches a communication system into an adequate communication system in accordance with a condition of wireless communication (a condition of communication line, communication network, or the like).

The wireless communication device according to the example embodiments includes a power amplifier (PA) which amplifies a transmission signal, which is transmitted by wireless communication, to a given power level. Further, the wireless communication device according to example embodiments selects the LTE or the WCDMA in accordance with a condition of wireless communication. Further, the wireless communication device controls power source voltage of the power amplifier by the envelope tracking system when the LTE is selected. On the other hand, the wireless communication device according to the first embodiment controls power source voltage of the power amplifier by the envelope elimination and restoration (EER) system when the WCDMA is selected.

Thus, the wireless communication device according to example embodiments controls the PA by the envelope tracking system in a case of the LTE and controls the PA by the EER in a case of the WCDMA. Accordingly, the wireless communication device is capable of selecting the optimal power saving method based on a communication speed and raising the performance of reduction in power consumption.

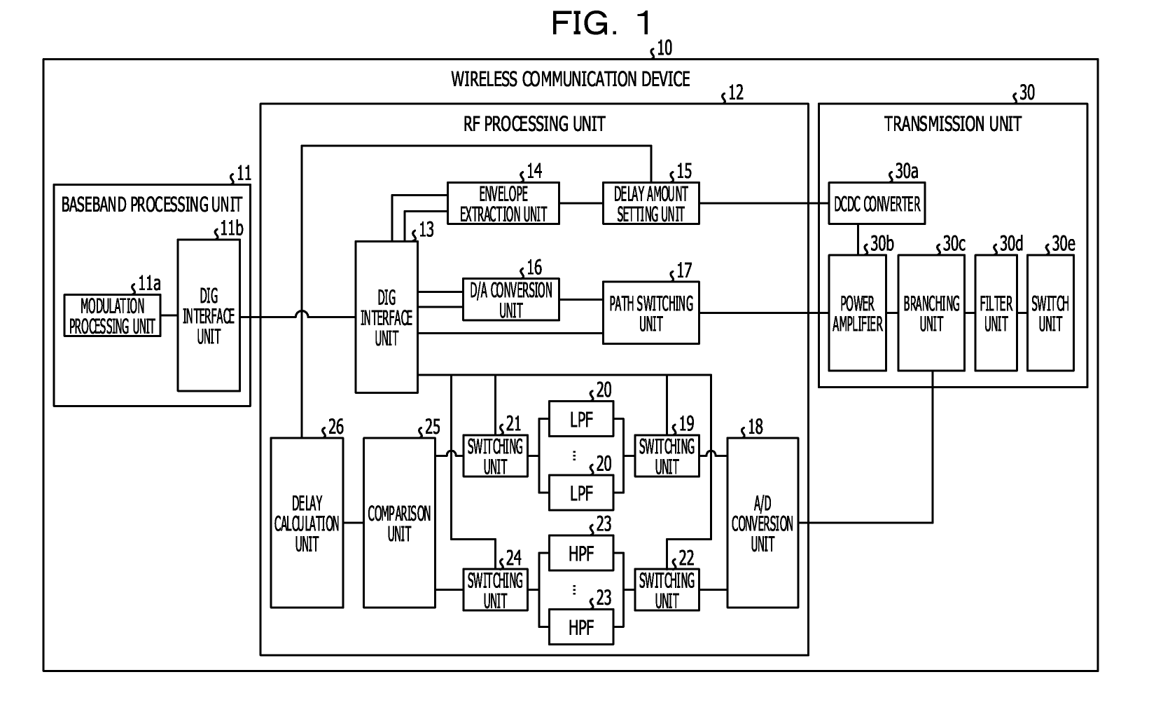

FIG. 1 is a functional block diagram illustrating the functional configuration of a wireless communication device, suitable for carrying out some example embodiments. As depicted in FIG. 1, this wireless communication device 10 includes a baseband processing unit 11, a radio frequency (RF) processing unit 12, and a transmission unit 30. Here, processing units illustrated here are exemplifications and other processing units may be included. For example, a display processing unit, a call processing unit, a mail processing unit, and the like which are included in a portable telephone may be included. Further, in FIG. 1, a functional block diagram of a reception system is omitted and a functional block diagram of a transmission system is illustrated so as to simplify description.

The baseband processing unit 11 includes a modulation processing unit 11a and a digital (DIG) interface unit 11b. The baseband processing unit 11 is a processing unit which executes baseband processing with respect to a transmission signal and a reception signal. For example, a modem circuit and the like which execute modulation and demodulation corresponding to the LTE and the WCDMA respectively correspond to the baseband processing unit 11.

The modulation processing unit 11a is a processing unit which modulates a signal which is a communication object into a signal suitable for wireless communication. For example, the modulation processing unit 11a decides a communication system to be used and a bandwidth based on a radio wave condition, notification from a base station, and the like. Then, the modulation processing unit 11a executes modulation processing corresponding to the decided communication system and outputs a modulation signal to the DIG interface unit 11b. Further, the modulation processing unit 11a outputs a control command for specifying the decided modulation system to the DIG interface unit 11b as well.

For example, when the modulation processing unit 11a decides the WCDMA as a communication system, the modulation processing unit 11a executes modulation processing corresponding to the WCDMA and outputs a modulation signal after the modulation and a control command indicating that the communication system is the WCDMA to the DIG interface unit 11b. Further, the modulation processing unit 11a executes modulation processing corresponding to the LTE when the modulation processing unit 11a decides the LTE of 10 MHz as a communication system. Then, the modulation processing unit 11a outputs a modulation signal after the modulation and a control command indicating that the communication system is the LTE of 10 MHz and indicating the number of resource blocks, for example, to the DIG interface unit 11b.

The DIG interface unit 11b is a processing unit which converts a modulation signal or the like into a signal of a signal format of the DIG RF or the like and transmits the signal so as to communicate with the RF processing unit 12 by a digital signal.

Specifically, the DIG interface unit 11b transmits a control command for identifying the WCDMA or the LTE and a modulation signal to the RF processing unit 12. For example, the DIG interface unit 11b transmits a modulation signal which is received from the modulation processing unit 11a, various types of modulation information, and a control command for specifying the number of resource blocks to a DIG interface unit 13 of the RF processing unit 12.

The RF processing unit 12 is a processing unit which executes transmission processing with respect to IQ signals which are received as modulation signals from the baseband processing unit 11, so as to generate a transmission signal. This RF processing unit 12 corresponds to large scale integration (RF-LSI), for example. However, it will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic.

The RF processing unit 12 includes the DIG interface unit 13, an envelope extraction unit 14, a delay amount setting unit 15, a digital/analog (D/A) conversion unit 16, and a path switching unit 17. The RF processing unit 12 further includes an analog/digital (A/D) conversion unit 18, a switching unit 19, a plurality of low pass filters (LPFs) 20, a switching unit 21, a switching unit 22, a plurality of high pass filters (HPFs) 23, a switching unit 24, a comparison unit 25, and a delay calculation unit 26.

The DIG interface unit 13 is a processing unit which receives a digital signal in a signal format of the DIG RF, for example, from the baseband processing unit 11. For example, the DIG interface unit 13 receives a modulation signal, a control command, and the like from the DIG interface unit 11b of the baseband processing unit 11. Further, the DIG interface unit 13 outputs the IQ signals received as the modulation signals to the envelope extraction unit 14.

Further, the DIG interface unit 13 outputs the IQ signals received as the modulation signals to the D/A conversion unit 16. Further, the DIG interface unit 13 issues the received control command and the like to the path switching unit 17, the switching unit 19, the switching unit 21, the switching unit 22, and the switching unit 24.

The envelope extraction unit 14 is a processing unit which performs addition-processing with respect to an I signal and a Q signal which are inputted from the DIG interface unit 13 so as to extract an envelope component and generate an envelope signal. Specifically, the envelope extraction unit 14 combines IQ signals and samples the signals by a digital/analog converter so as to extract an envelope component.

For example, when a transmission signal is transmitted in a bandwidth obtained by dispersion to a bandwidth of 3.84 MHz, the bandwidth of 3.84 MHz of this carrier wave corresponds to a frequency component of amplitude variation of a carrier wave carrier. Therefore, the envelope extraction unit 14 extracts a frequency component of 3.84 MHz as an envelope and outputs the frequency component to a DCDC converter 30a via the delay amount setting unit 15.

The delay amount setting unit 15 is a processing unit which corrects delay of an envelope signal which is inputted from the envelope extraction unit 14. Specifically, the delay amount setting unit 15 delays an envelope signal which is inputted from the envelope extraction unit 14 by a delay amount notified by the delay calculation unit 26 so as to output the envelope signal which is delayed to the DCDC converter 30a. For example, the delay amount setting unit 15 executes delay processing based on an envelope component so as to synchronize timing at which the DCDC converter 30a applies power source voltage of a power amplifier 30b with timing at which an input signal is inputted into the power amplifier 30b.

The D/A conversion unit 16 is a processing unit which combines modulation signals which are inputted from the DIG interface unit 13, that is, IQ signals and executes filter processing so as to convert the IQ signals into analog signals. Further, the D/A conversion unit 16 up-converts the modulation signals by a carrier wave of the RF frequency. Then, the D/A conversion unit 16 outputs the modulation signals which are up-converted to the path switching unit 17.

The path switching unit 17 executes path switching to the power amplifier 30b for control by the envelope tracking system when the LTE is selected, and executes path switching to the power amplifier 30b for control by the EER system when the WCDMA is selected.

Specifically, the path switching unit 17 determines a communication system based on a control command or the like which are received via the DIG interface unit 13. Then, the path switching unit 17 outputs a modulation signal to the power amplifier 30b by using a linear amplifying path in a case of the envelope tracking system. Further, the path switching unit 17 allows only a phase modulation component to pass through by making a modulation signal pass through a path of a saturation amplifier such as a limiter amplifier, so as to output the phase modulation component to the power amplifier 30b in a case of the EER system.

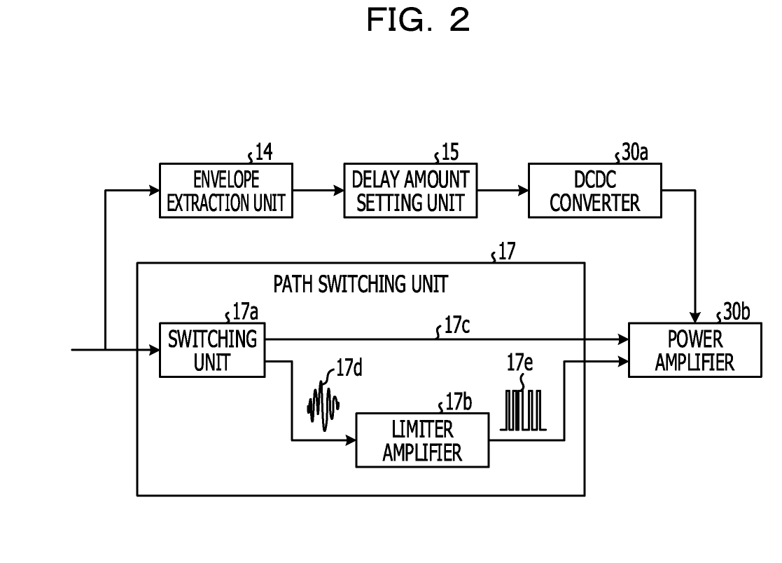

Here, an example of path switching is described. FIG. 2 illustrates the path switching. FIG. 2 illustrates a configuration example of the path switching unit 17 and other processing units are omitted for the sake of simplicity. As depicted in FIG. 2, the path switching unit 17 includes a switching unit 17a and a limiter amplifier 17b.

The switching unit 17a switches output paths of a modulation signal which is inputted from the D/A conversion unit 16, based on a control command or the like which is received via the DIG interface unit 13. When it is specified that the LTE is selected based on the control command or the like, for example, the switching unit 17a outputs the modulation signal to the power amplifier 30b via a path 17c of linear amplification.

On the other hand, when it is specified that the WCDMA is selected based on the control command or the like, the switching unit 17a outputs the modulation signal to the limiter amplifier 17b. The limiter amplifier 17b generates an output signal 17e which is obtained by converting an amplification component of a modulation signal 17d which is inputted to a certain level, and outputs the output signal 17e to the power amplifier 30b.

Here, even when it is specified that the LTE is selected based on the control command or the like, the switching unit 17a may output the modulation signal to the limiter amplifier 17b in a case where a bandwidth is equal to or less than 5 MHz.

Further, a part of the modulation signal is inputted not only into the path switching unit 17 but also into the envelope extraction unit 14. Then, an envelope component of the modulation signal is extracted by the envelope extraction unit 14, then delayed by the delay amount setting unit 15, and inputted into the DCDC converter 30a. Subsequently, the DCDC converter 30a controls power source voltage of the power amplifier 30b in accordance with the envelope component.

Referring back to FIG. 1, the A/D conversion unit 18 is a processing unit which converts a part of transmission signals which are analog signals inputted from the branching unit 30c into digital signals. Specifically, the A/D conversion unit 18 down-converts a part of transmission signals so as to re-convert the signals into IQ signals. Then, the A/D conversion unit 18 outputs digital signals obtained by the conversion into the switching unit 19 and the switching unit 22.

The switching unit 19 is a processing unit which switches output destinations based on a control command or the like which is received via the DIG interface unit 13. For example, the switching unit 19 switches an output destination into an LPF 20 which corresponds to a communication system which is specified by the control command or the like, and outputs a digital signal which is inputted from the A/D conversion unit 18 to the corresponding LPF 20.

A plurality of LPFs 20 are low pass filters or the like which correspond to respective bandwidths available by the wireless communication device 10 and are processing units which filter a digital signal which is inputted from the switching unit 19. For example, the LPFs 20 are filters corresponding to WCDMA, LTE (1.4 MHz), LTE (3 MHz), LTE (5 MHz), LTE (10 MHz), LTE (15 MHz), and LTE (20 MHz) respectively. In another example embodiment, LPF 20 are configured to the 700 MHZ band corresponding to Public Safety LTE. Moreover, it will be appreciated that LPFS 20 can be configured to other frequencies corresponding to other communications systems such as GSM, EDGE, CDMA2000 and the like.

The switching unit 21 is a processing unit which switches input destinations based on a control command or the like which is received via the DIG interface unit 13. For example, the switching unit 21 switches an input destination into an LPF 20 which corresponds to a bandwidth which is specified by the control command or the like, and receives a signal after filtering from the LPF 20 which is the input destination. Then, the switching unit 21 outputs the received signal after the filtering to the comparison unit 25.

The switching unit 22 is a processing unit which switches output destinations based on a control command or the like which is received via the DIG interface unit 13. For example, the switching unit 22 switches an output destination into an HPF 23 which corresponds to a bandwidth which is specified by the control command or the like, and outputs a digital signal which is inputted from the A/D conversion unit 18 to the corresponding HPF 23.

A plurality of HPFs 23 are high pass filters or the like which correspond to respective bandwidths available by the wireless communication device 10 and are processing units which filter a digital signal which is inputted from the switching unit 22. For example, the HPFs 23 are filters corresponding to WCDMA, LTE (1.4 MHz), LTE (3 MHz), LTE (5 MHz), LTE (10 MHz), LTE (15 MHz), and LTE (20 MHz) respectively.

The switching unit 24 is a processing unit which switches input destinations based on a control command or the like which is issued by the DIG interface unit 13. For example, the switching unit 24 switches an input destination into an HPF 23 which corresponds to a bandwidth which is specified by the control command or the like, and receives a signal after filtering from the HPF 23 which is the input destination. Then, the switching unit 24 outputs the received signal after the filtering to the comparison unit 25.

The comparison unit 25 is a processing unit which compares an output result from the switching unit 21 with an output result from the switching unit 24. For example, the comparison unit 25 compares a low-pass-filtered signal which is inputted from the switching unit 21 with a high-pass-filtered signal which is inputted from the switching unit 24. Accordingly, the comparison unit 25 is capable of comparing distortion components of an upper frequency in a transmission signal with distortion components of a lower frequency in the transmission signal, and thus capable of detecting a balance of distortion amounts. Then, the comparison unit 25 outputs a comparison result to the delay calculation unit 26.

The delay calculation unit 26 is a processing unit which decides a delay amount in accordance with an output result from the comparison unit 25. Specifically, the delay calculation unit 26 is capable of deciding a delay amount by using a various methods of related art, but the delay calculation unit 26 is also capable of deciding a delay amount by using a look up table or the like, for example. For example, the delay calculation unit 26 holds a look up table in which a distortion amount and a delay amount are preliminarily associated with each other. The delay calculation unit 26 receives a comparison result which indicates how much the distortion amount of the upper frequency or the lower frequency is larger than that of the other frequency, from the comparison unit 25. Subsequently, the delay calculation unit 26 specifies a delay amount corresponding to the received distortion amount based on the look up table and outputs the specified delay amount to the delay amount setting unit 15.

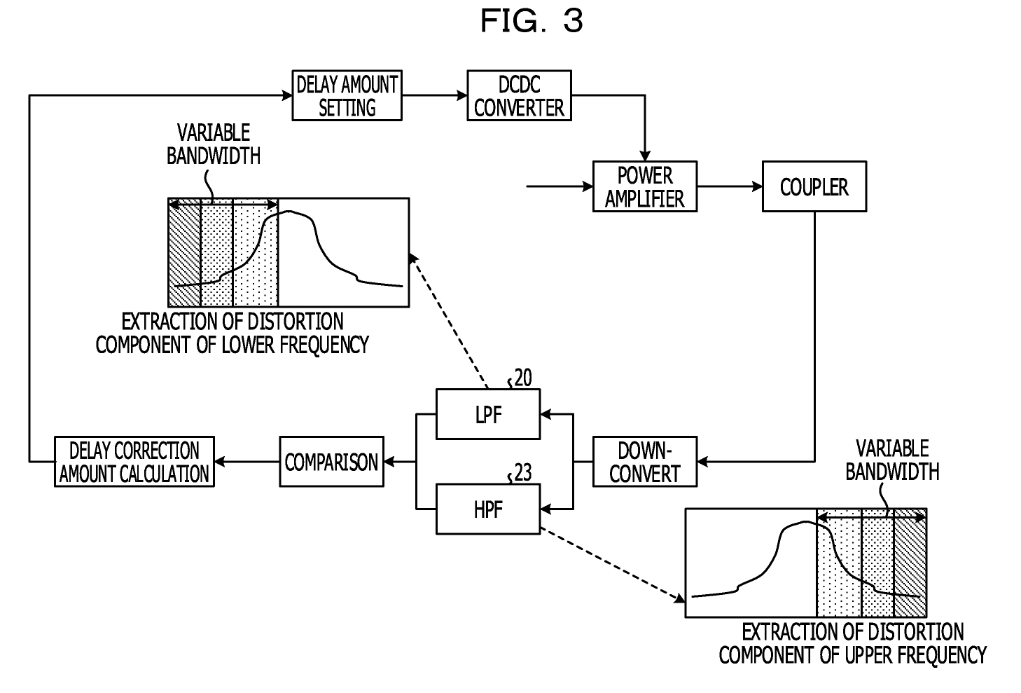

Here, a calculation example of a delay amount is described with reference to FIG. 3. FIG. 3 illustrates a calculation example of a delay amount. As depicted in FIG. 3, a transmission signal which is outputted from a power amplifier is branched to an antenna and a feedback circuit by using a coupler and the like.

A feedback signal which is branched from the coupler is down-converted to be inputted into a LPF 20. Then, the transmission signal after the down conversion is filtered in the LPF 20 and a distortion component of a lower-limit frequency is extracted. Here, employment of a LPF 20 which corresponds to a bandwidth which is used in wireless communication permits a cut-off frequency to be variable and thus enables the filtering.

In a similar manner, a feedback signal which is branched from the coupler is down-converted to be inputted into a HPF 23, as well. Then, the transmission signal after the down-converting is filtered in the HPF 23 and a distortion component of an upper-limit frequency is extracted. Here, employment of a HPF 23 which corresponds to a bandwidth which is used in wireless communication permits a cut-off frequency to be variable and thus enables the filtering, as well.

Subsequently, a filtering result of the LPF 20 and a filtering result of the HPF 23 are compared with each other so as to detect a balance of distortion amounts. A delay amount is decided based on the balance of distortion amounts, which is detected here. Then, output of an envelope component is delayed by the determined delay amount. Consequently, the DCDC converter is capable of altering application timing of power source voltage to the power amplifier at anytime.

Referring back to FIG. 1, the transmission unit 30 is a processing unit which outputs a transmission signal from an antenna. This transmission unit 30 includes the DCDC converter 30a, the power amplifier 30b, the branching unit 30c, a filter unit 30d, and a switch unit 30e.

The DCDC converter 30a is a processing unit which applies power source voltage of the power amplifier 30b in accordance with an envelope signal which is inputted from the delay amount setting unit 15. For example, the DCDC converter 30a raises power source voltage of the power amplifier when the amplitude of a modulation signal is large, and the DCDC converter 30a lowers power source voltage of the power amplifier when the amplitude of a modulation signal is small.

The power amplifier 30b is a processing unit which amplifies a modulation signal which is inputted from the D/A converter 16 to a power level of a given value. Specifically, the power amplifier 30b outputs a transmission signal which is obtained by amplifying a modulation signal, to the branching unit 30c in accordance with a control signal of power source voltage which is inputted by the DCDC converter 30a in accordance with an envelope signal.

For example, a trajectory of an amplification variation peak of a modulation signal is an envelope (envelope curve). Therefore, an occupied bandwidth becomes wider and a speed becomes higher as data communication is performed with a higher speed. In a case of control by employing the envelope tracking system, power source voltage of the power amplifier 30b is variable by a speed corresponding to a frequency of an envelope signal.

On the other hand, in a case of control by employing the EER system, a phase modulation component of a modulation signal is amplified by a switching amplifier. Further, power source voltage of the power amplifier 30b is varied in accordance with amplification variation of a modulation signal. Accordingly, a modulation signal is reproduced by output of the power amplifier 30b. Thus, in the case of the control by the EER system, the power amplifier 30b is operated by switching. As a result, performance of reduction in power consumption of the EER system is superior to that of the envelope tracking system.

The branching unit 30c is a processing unit such as a coupler which branches a transmission signal which is outputted from the power amplifier 30b to the filter unit 30d and the A/D conversion unit 18. That is, the branching unit 30c feeds back a part of a transmission signal so as to correct a delay amount in the device.

The filter unit 30d is a processing unit which filters a transmission signal which is inputted from the branching unit 30c and outputs the signal to the switch unit 30e. The switch unit 30e is a processing unit which outputs a transmission signal to an antenna. When a frequency in communication is another frequency, this switch unit 30e switches a signal to a signal of the other frequency and outputs the signal to the antenna.

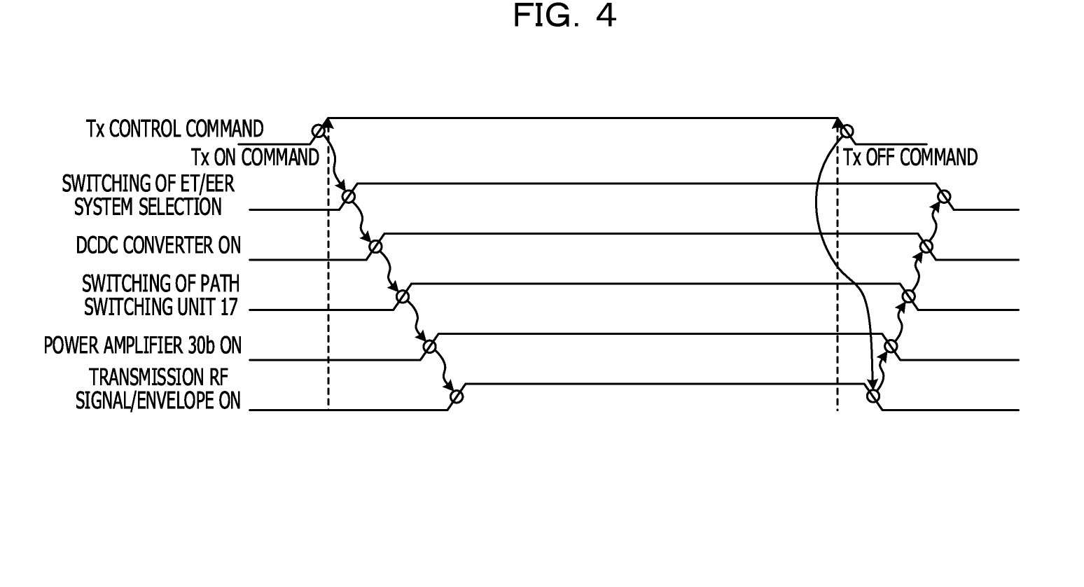

Subsequently, a process from decision of a control system to control of power source of the power amplifier 30b is described. FIG. 4 illustrates a processing sequence of path switching. Here, an example in which the baseband processing unit 11 is composed of a baseband circuit and the RF processing unit 12 is composed of a RF circuit is described.

Switching between the envelope tracking system and the EER system is performed based on a signal of RF-LSI control at time of inter RAT which is time of switching of WCDMA/LTE system. In selection of a system, control of searching a condition of wireless communication is performed on the baseband circuit side. Based on a selection result of the system, the baseband circuit sets a command of transmission (Tx) control with respect to the RF circuit.

The RF circuit which receives the command corresponding to each system issues an ON command of a transmission signal so as to perform an operation of controlling a wireless circuit. In LTE communication, information of the number of resource blocks is also transmitted to the RF processing unit, being able to identify a bandwidth. Thus, the envelope tracking system and the EER system are switched in accordance with the bandwidth.

After the control system of the power amplifier 30b is decided, each RF circuit is started up so as to maintain wireless performance based on the Third Generation Partnership Project (3GPP) standard. As an order of the start up, the DCDC converter 30a which is a power source circuit which supplies power source to the power amplifier 30b is first started up. Then, the path switching unit 17 which is an antenna switch which decides the RF circuit is started up, and subsequently, the power amplifier 30b is started up. After that, a transmission RF signal is transmitted to the power amplifier 30b. At this time, an envelope signal which has been subjected to delay correction is also transmitted to the DCDC converter 30a which controls the power source of the power amplifier 30b, so as to perform power source control of the power amplifier 30b.

On the other hand, after the transmission completion of a transmission signal, an OFF command of a transmission signal is notified in an order reversed to that of the above-described order and the transmission processing of a transmission signal is completed. Specifically, after the completion of transmission, an OFF command is issued from the baseband circuit side to the RF circuit. After that, the envelope extraction unit 14 is notified of the OFF command, and the power amplifier 30b, the path switching unit 17, and the DCDC converter 30a are sequentially notified of the OFF command. Thus, the processing is ended in sequence. As a result, the switching control between the envelope tracking system and the EER system is ended.

Subsequently, a flowchart of processing which is executed by the wireless communication device according to the first embodiment is described. Path switching processing and delay correction processing are described here.

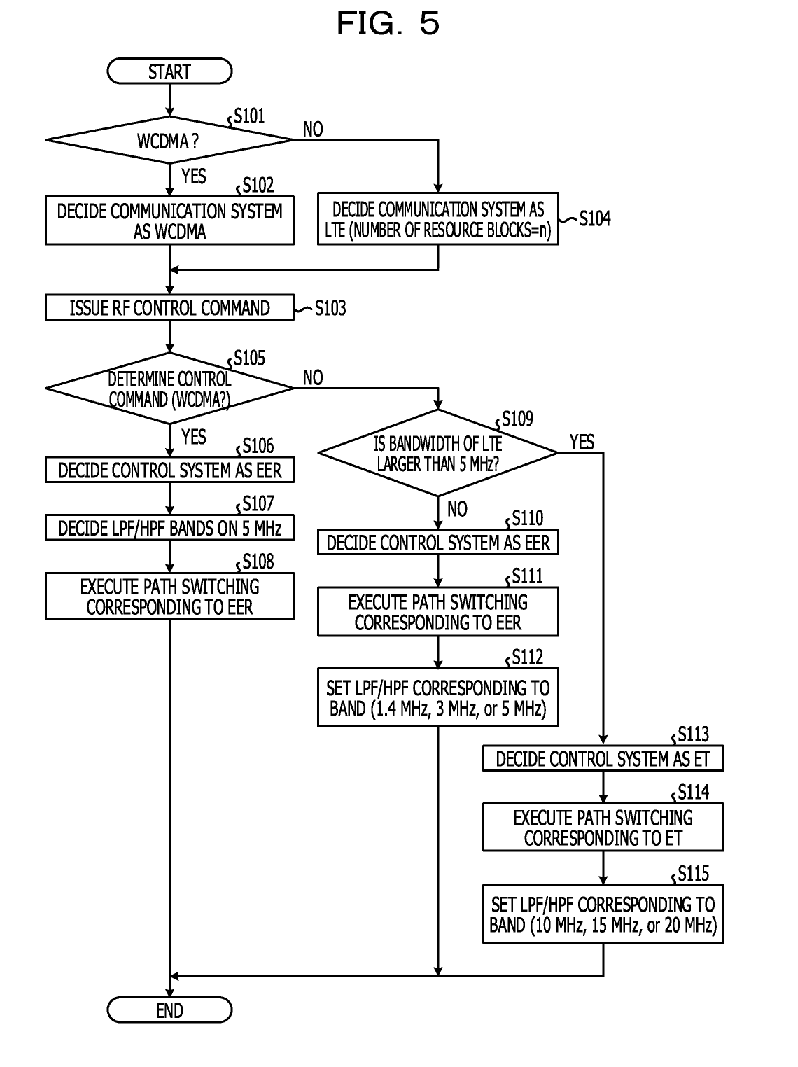

FIG. 5 is a flowchart illustrating a process of path switching processing. As depicted in FIG. 5, the modulation processing unit 11a of the baseband processing unit 11 of the wireless communication device 10 determines whether or not a communication system is the WCDMA, by search of a condition of wireless communication, for example, (S101).

When the modulation processing unit 11a determines that the communication system is the WCDMA (S101: Yes), the modulation processing unit 11a decides to use the WCDMA (S102). Then, the DIG interface unit 11b issues a control command which is a command notifying of the use of the WCDMA and corresponding to the WCDMA, to the RF processing unit 12 (S103).

On the other hand, when the modulation processing unit 11a determines that the communication system is not the WCDMA (S101: No), the modulation processing unit 11a decides to use the LTE (S104). At this time, the modulation processing unit 11a decides the number of resource blocks. Then, the DIG interface unit 11b issues a control command which is a command notifying of the use of the LTE and the number of resource blocks and corresponding to the LTE which is decided, to the RF processing unit 12 (S103).

Subsequently, the path switching unit 17 of the RF processing unit 12 determines a control command which is received from the baseband processing unit 11 via the DIG interface unit 13 (S105).

Then, when the path switching unit 17 determines that the WCDMA is selected based on the control command (S105: Yes), the path switching unit 17 decides the control system as the EER (S106). Subsequently, the switching unit 19 and the switching unit 21 switch a connecting destination to a LPF 20 which corresponds to 5 MHz and the switching unit 22 and the switching unit 24 switch a connecting destination to a HPF 23 which corresponds to 5 MHz, in accordance with the control command (S107). Then, the path switching unit 17 switches a route toward the power amplifier 30b to a path corresponding to the EER (S108). Here, either S107 or S108 may be executed first.

On the other hand, when the path switching unit 17 determines that the LTE is selected instead of the WCDMA based on the control command (S105: No), the path switching unit 17 determines whether or not a bandwidth of the LTE which is selected is equal to or less than 5 MHz (S109).

Then, when the path switching unit 17 determines that the bandwidth of the LTE which is selected is equal to or less than 5 MHz (S109: No), the path switching unit 17 decides the control system as the EER (S110). Then, the path switching unit 17 switches a route toward the power amplifier 30b to a path corresponding to the EER (S111). Subsequently, the switching unit 19 and the switching unit 21 switch a connecting destination to a LPF 20 which corresponds to the selected frequency and the switching unit 22 and the switching unit 24 also switch a connecting destination to a HPF 23 which corresponds to the selected frequency, in accordance with the control command (S112). Here, either S111 or S112 may be executed first.

Further, when the path switching unit 17 determines that the bandwidth of the LTE which is selected is larger than 5 MHz (S109: Yes), the path switching unit 17 decides the control system as the envelope tracking (ET) (S113). Then, the path switching unit 17 switches a route toward the power amplifier 30b to a path corresponding to the ET (S114). Subsequently, the switching unit 19 and the switching unit 21 switch a connecting destination to a LPF 20 which corresponds to the selected frequency and the switching unit 22 and the switching unit 24 also switch a connecting destination to a HPF 23 which corresponds to the selected frequency, in accordance with the control command (S115). Here, either S114 or S115 may be executed first.

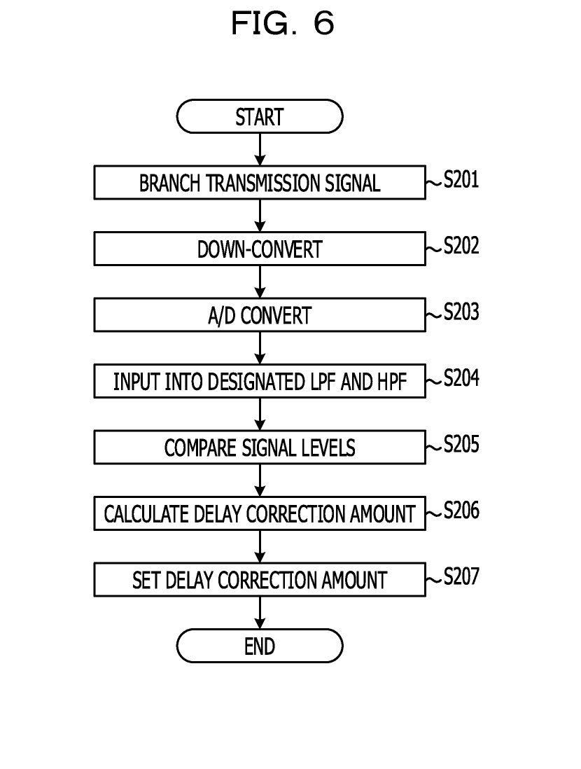

FIG. 6 is a flowchart illustrating a process of delay correction processing. As depicted in FIG. 6, the branching unit 30c of the transmission unit 30 branches a part of a transmission signal which is outputted from the power amplifier 30b, so as to feed back the part of the transmission signal to the RF processing unit 12 (S201).

Then, the A/D conversion unit 18 of the RF processing unit 12 down-converts the branched transmission signal to a signal of a bandwidth close to a baseband (S202). Subsequently, the A/D conversion unit 18 converts the down-converted signal into a digital signal (S203).

Subsequently, the switching unit 19 inputs the signal which is outputted from the A/D conversion unit 18 into a designated LPF 20 and the switching unit 22 inputs the signal which is outputted from the A/D conversion unit 18 into a designated HPF 23 (S204). For example, the switching unit 19 and the switching unit 22 input a signal into a filter corresponding to a bandwidth specified by the control command or the like.

Then, the comparison unit 25 compares a signal level after filtering by the LPF 20 with a signal level after filtering by the HPF 23 (S205). Subsequently, the delay calculation unit 26 calculates a delay correction amount based on a comparison result obtained by the comparison unit 25 (S206). Then, the delay amount setting unit 15 sets the delay correction amount which is calculated by the delay calculation unit 26 as a delay amount (S207).

As described above, signals which have passed through the LPF 20 and the HPF 23 have power of only a third order distortion component and are transmitted to a circuit which compares respective power levels. When a transmission signal which is inputted into the power amplifier 30b and an envelope signal of the power source of the power amplifier 30b are not synchronized with each other, there is a difference between the distortion signal component which has passed through the LPF 20 and the distortion signal component which has passed through the HPF 23. That is, distortion amounts are different from each other. Therefore, comparison of both levels enables discrimination of generation of a gap between delay amounts. Transmission of a correction amount which is calculated for the minimum difference or a correction amount which has been stored in a look up table or the like to the delay amount setting unit 15 realizes execution of control for an optimum delay amount.

Thus, the wireless communication device 10 according to certain embodiments executes control for reduction in power consumption by using the envelope tracking system in the LTE which is high-speed data communication. Further, the wireless communication device 10 selects the envelope tracking system or the EER system in accordance with a scalable bandwidth operation in the LTE communication. For example, the wireless communication device 10 selects the EER when an occupied bandwidth is narrow even in the LTE communication. Further, the wireless communication device 10 executes control for reduction in power consumption by using the EER system in the WCDMA communication which is low-speed data communication.

Thus, the wireless communication device 10 in certain embodiments is a multi-mode radio which performs communication in a plurality of communication systems of which communication speeds are different from each other and is capable of switching control systems of the power amplifier in accordance with a communication speed, being able to execute communication in a state of an optimum efficiency performance of the power amplifier.

Further, the wireless communication device 10 in certain embodiments is capable of detecting imbalance between a distortion amount of an upper frequency of a third order distortion and a distortion amount of a lower frequency, comparing the imbalanced distortion amounts with each other, and calculating delay amounts of the same level. Thus, the wireless communication device 10 is capable of adaptively correcting a delay correction amount during an operation. Accordingly, the wireless communication device 10 is capable of securing synchronization by monitoring distortion levels of transmission signals and realizing reduction in power consumption and stability of signal quality.

The embodiments of the present disclosure have been described thus far, but the present disclosure may be embodied in various types of different forms other than the above-described example embodiments. Other example embodiments are described below.

The LTE and the WCDMA have been described as examples of the high-speed communication and the low-speed communication respectively in the first embodiment, but communication systems are not limited to these examples. For example, communication of which a bandwidth is equal to or larger than 20 MHz may be set as high-speed communication to be processed in a similar manner to the above-described embodiment. Further, a control system of the power amplifier is not limited to the ET system and the EER system, but other various types of systems may be employed.

Other examples of high-speed communication and the low-speed communication suitable are a long term evolution (LTE) communication system, or LTE-advanced (LTE-A) communication system, or LTE-Beyond (LTE-B) communication system, or on a First Responder Network Authority Nationwide Broadband Network (FirstNet) communication system, a Global System for Mobile Communication (GSM) communication system, a GSM Evolution (EDGE) Radio Access Network (GERAN) communication system, or a CDMA2000 communication system, or a land mobile radio system (LMRS) communication system, or other public land mobile radio or private land mobile radio system a Wi-Fi local area network (WILAN), or a vehicle area network (VANET), or a WiMAX network or mobile satellite service (MSS) ancillary terrestrial components (ATC).

A bandwidth which is a switching border between the EER and the ET is preliminarily determined based on efficiency performance of the DCDC converter and efficiency performance of the power amplifier. The switching point may be stored as an initial value on firmware of the RF-LSI, as the programmable configuration.

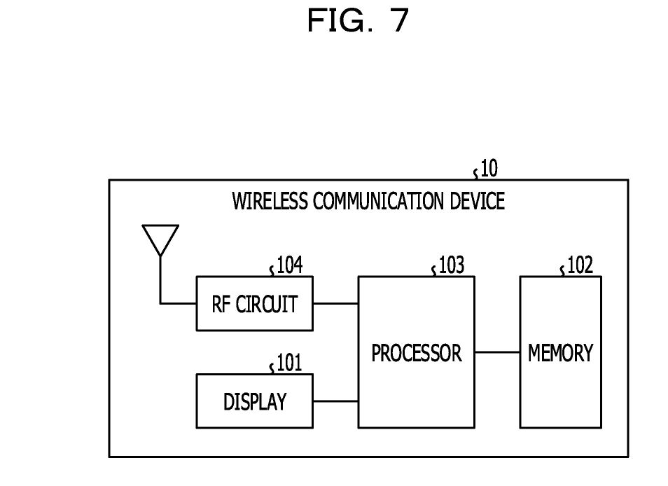

The wireless communication device 10 according to the first embodiment is realized by a portable telephone or a smartphone, for example. FIG. 7 illustrates a hardware configuration example of the wireless communication device 10. As depicted in FIG. 7, the wireless communication device 10 includes a display device 101, a memory 102, a processor 103, and an RF circuit 104.

The display device 101 is a display such as a liquid crystal display (LCD), for example. The memory 102 is a RAM such as a synchronous dynamic random access memory (SDRAM), a read only memory (ROM), and a flash memory, for example. Memory 103 is suitable for tangibly embodying a program of instructions or operations such as computer instructions suitable for carrying out example embodiments as executable by the machine for causing performance of the instructions or operations.

Respective processing units of the RF processing unit 12 and the transmission unit 30 which have been described with reference to FIG. 1 are realized by the RF circuit 104 or the processor 103, for example. The baseband processing unit 11 which has been described with reference to FIG. 1 is realized by the processor 103, for example. Here, the wireless communication device 10 may include a digital signal processor (DSP) and the like. However, it will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic.

Further, among respective processing which has been described in the embodiment, all or a part of processing which has been described as the processing which is automatically performed may be manually performed. Alternatively, all or a part of processing which has been described as the processing which is manually performed may be automatically performed by a method of related art. Further, processing procedures, control procedures, specific names, and information including various types of data and parameters, which have been illustrated in the foregoing description and drawings, may be arbitrarily changed except for a case which is specially noted.

Further, respective constituent elements of respective devices which are illustrated in the drawings are functional-ideational elements and do not have to be physically configured as illustrated. That is, specific embodiments of dispersion and integration of respective devices are not limited to those illustrated. Namely, all or a part of devices may be configured to be functionally or physically dispersed or integrated in an arbitrary unit in accordance with various types of loads and usage conditions. Further, all or an arbitrary part of processing functions which are performed in respective devices may be realized by a central processing unit (CPU) or a program which is analyzed and executed in the CPU or realized as hardware by the wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device, comprising:
an amplifier configured to amplify a transmission signal to a given power level, the transmission signal being transmitted in wireless communication; and
a processor coupled to the amplifier and configured to:
select a communication protocol that is used for the wireless communication, from among a plurality of communication protocols including a first communication protocol and a second communication protocol of a lower communication speed than the first communication protocol, in accordance with a condition of the wireless communication, and
control power source voltage of the amplifier by a control scheme determined in accordance with a communication speed of the selected communication protocol.

2. The wireless communication device according to claim 1, wherein
the processor is configured to:
control the power source voltage by a first control scheme, when the processor selects the first communication protocol, and
control the power source voltage by a second control scheme for the lower communication speed, when the processor selects the second communication protocol.

3. The wireless communication device according to claim 1, wherein
the processor is configured to:
control power source voltage of the amplifier by a control scheme that performs correcting a delay amount of timing for applying the power source voltage in accordance with a communication speed of the selected communication protocol.

4. The wireless communication device according to claim 1, wherein
the processor is configured to:
control the power source voltage by a first control scheme, when the processor selects the first communication protocol, and
control the power source voltage by a second control scheme that performs correcting a delay amount of timing for applying the power source voltage for the lower communication speed, when the processor selects the second communication protocol.

5. The wireless communication device according to claim 1, wherein
the processor is configured to control the power source voltage by a control scheme determined in accordance with the communication speed of the selected communication protocol and a bandwidth used in the selected communication protocol.

6. The wireless communication device according to claim 1, wherein
the processor is configured to
control the power source voltage by a first control scheme, when the processor selects the first communication protocol and a bandwidth used in the first communication protocol is more than or equal to a given value, and
control the power source voltage by a second control scheme for the lower communication speed, when the processor selects the first communication protocol and the bandwidth is less than the given value or the processor selects the second communication protocol.

7. The wireless communication device according to claim 1, wherein
the processor is configured to:
extract, from a signal obtained by extracting a part of a transmission signal that is outputted from the amplifier and by down-converting the part of the transmission signal, a third order distortion component in a higher frequency than a center frequency of the signal, and another third order distortion component in a lower frequency than the center frequency,
calculate a correction amount based on a difference between the respective third order distortion components, and
correct a delay amount of timing for applying the power source voltage of the amplifier, by using the calculated correction amount.

8. The wireless communication device according to claim 7, wherein
the processor is configured to:
extract the third order distortion component from the signal after the down-converting, by using a high pass filter corresponding to a bandwidth used in the wireless communication, and
extract the other third order distortion component from the signal after the down-converting, by using a low pass filter corresponding to the bandwidth used in the wireless communication.

9. The wireless communication device according to claim 2, wherein the first control scheme is an envelope tracking and the second control scheme is an envelope elimination and restoration.

10. A wireless communication circuit, comprising:
a memory; and
a processor coupled to the memory and configured to:
select a communication protocol that is used for wireless communication, from among a plurality of communication protocols including a first communication protocol and a second communication protocol of a lower communication speed than the first communication protocol, in accordance with a condition of the wireless communication in which a transmission signal is transmitted, and
control power source voltage of an amplifier amplifying the transmission signal to a given power level, by a control scheme determined in accordance with a communication speed of the selected communication protocol.

11. A power control method, comprising:
selecting a communication protocol that is used for wireless communication, from among a plurality of communication protocols including a first communication protocol and a second communication protocol of a lower communication speed than the first communication protocol, in accordance with a condition of the wireless communication in which a transmission signal is transmitted; and
controlling, using a processor, power source voltage of an amplifier amplifying the transmission signal to a given power level, by a control scheme determined in accordance with a communication speed of the selected communication protocol.

12. The power control method according to claim 11, wherein
the controlling includes:
controlling the power source voltage by a first control scheme, when the processor selects the first communication protocol, and
controlling the power source voltage by a second control scheme for the lower communication speed, when the processor selects the second communication protocol.

13. The power control method according to claim 11, wherein
the controlling includes controlling power source voltage of the amplifier by a control scheme that performs correcting a delay amount of timing for applying the power source voltage in accordance with a communication speed of the selected communication protocol.

14. The power control method according to claim 11, wherein
the controlling includes:
controlling the power source voltage by a first control scheme, when the processor selects the first communication protocol, and
controlling the power source voltage by a second control scheme that performs correcting a delay amount of timing for applying the power source voltage for the lower communication speed, when the processor selects the second communication protocol.

15. The power control method according to claim 11, wherein
the controlling includes controlling the power source voltage by a control scheme determined in accordance with the communication speed of the selected communication protocol and a bandwidth used in the selected communication protocol.

16. The power control method according to claim 11, wherein
the controlling includes:
controlling the power source voltage by a first control scheme, when the processor selects the first communication protocol and a bandwidth used in the first communication protocol is more than or equal to a given value, and
controlling the power source voltage by a second control scheme for the lower communication speed, when the processor selects the first communication protocol and the bandwidth is less than the given value or the processor selects the second communication protocol.

17. The power control method according to claim 11, further comprising:
extracting, from a signal obtained by extracting a part of a transmission signal that is outputted from the amplifier and by down-converting the part of the transmission signal, a third order distortion component in a higher frequency than a center frequency of the signal, and another third order distortion component in a lower frequency than the center frequency;
calculating a correction amount based on a difference between the respective third order distortion components; and
correcting a delay amount of timing for applying the power source voltage of the amplifier, by using the calculated correction amount.

18. The power control method according to claim 17, wherein
the extracting includes:
extracting the third order distortion component from the signal after the down-converting, by using a high pass filter corresponding to a bandwidth used in the wireless communication, and
extracting the other third order distortion component from the signal after the down-converting, by using a low pass filter corresponding to the bandwidth used in the wireless communication.

19. The power control method according to claim 12, wherein the first control scheme is an envelope tracking and the second control scheme is an envelope elimination and restoration.
